(19) United States
(12) Patent Application Publication
(10) Pub. No.: US 2024/0404500 A1
(43) Pub. Date: Dec. 5, 2024

(54) AUTOMATIC ADAPTIVE NOISE CANCELLATION FOR ELECTRONIC DEVICES

(71) Applicant: Apple Inc., Cupertino, CA (US)

(72) Inventors: Hanchi CHEN, Mountain View, CA (US); Jianjun HE, San Jose, CA (US); Mark P. NOON, San Jose, CA (US); Tony S. VERMA, San Francisco, CA (US); Vladan BAJIC, San Francisco, CA (US); Yang LU, San Jose, CA (US); Yue ZHAO, San Jose, CA (US); Esge B. ANDERSEN, Campbell, CA (US); Mitchell R. LERNER, San Francisco, CA (US); Taylor G. CARRIGAN, San Francisco, CA (US); Zhangli CHEN, San Jose, CA (US)

(21) Appl. No.: 18/656,509

(22) Filed: May 6, 2024

Related U.S. Application Data
(60) Provisional application No. 63/470,818, filed on Jun. 2, 2023.

(51) Int. Cl. G10K 11/178

(52) U.S. Cl. CPC G10K 11/17854

(57) ABSTRACT

Aspects of the subject technology provide for automatic adaptive noise cancellation, which may be provided with a substantially flat frequency response. In one or more implementations, a noise cancellation signal is combined with a pass-through audio signal with a ratio that is controlled based on a mixing curve. The mixing curve may be one of multiple mixing curves that are defined for multiple respective operational states of an electronic device.

### CROSS REFERENCE TO RELATED APPLICATIONS

This application claims the benefit of priority to U.S. Provisional Patent Application No. 63/470,818, entitled, “AUTOMATIC ADAPTIVE NOISE CANCELLATION FOR ELECTRONIC DEVICES”, filed on Jun. 2, 2023, the disclosure of which is hereby incorporated herein in its entirety.

### TECHNICAL FIELD

The present description relates generally to electronic devices, including, for example, automatic adaptive noise cancellation for electronic devices.

### BACKGROUND

An electronic device may include one or more microphones. The one or more microphones may produce audio signals which include sound from one or more sources in the physical environment of the electronic device. Some electronic devices have the capability of generating an anti-noise signal to acoustically cancel the sound from the one or more sources.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of an example electronic device that may implement aspects of the subject technology in accordance with one or more implementations.

FIG. 2 illustrates a diagram of another example electronic device that may implement aspects of the subject technology in accordance with one or more implementations.

FIG. 3 illustrates a block diagram of an audio signal processing architecture for an electronic device in accordance with one or more implementations.

FIG. 4 illustrates additional details that may be implemented in the audio signal processing architecture of FIG. 3 in accordance with one or more implementations.

FIG. 5 illustrates various examples of mixing curves in accordance with one or more implementations.

FIG. 6 illustrates a block diagram of another audio signal processing architecture for an electronic device in accordance with one or more implementations.

FIG. 7 illustrates an example of modifications to a mixing curve based on a user input in accordance with one or more implementations.

FIG. 8 illustrates an example user interface for providing a user input to adjust an amount of ambient sound in an automatic adaptive noise cancellation operation in accordance with one or more implementations.

FIG. 9 illustrates additional examples of modifications to a mixing curve based on user inputs using the user interface of FIG. 8 in accordance with one or more implementations.

FIG. 10 illustrates examples of gain curves in accordance with one or more implementations.

FIG. 11 illustrates additional details that may be implemented in the audio signal processing architecture of FIG. 6 in accordance with one or more implementations.

FIG. 12 illustrates additional details that may be implemented in the audio signal processing architecture of FIG. 11 in accordance with one or more implementations.

FIG. 13 illustrates a flow diagram of an example process for automatic adaptive noise cancellation in accordance with one or more implementations.

FIG. 14 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Audio devices, such as headphones and/or earbuds can provide active noise cancellation (ANC) in which a microphone of the headphones and/or earbuds (and/or a connected electronic device) receives an audio signal including ambient noise from the environment around the headphones and/or earbuds, and the audio device generates an anti-noise signal that, when output by a speaker, cancels some or all of the ambient noise before the ambient noise is received in the ear canal of the user.

However, in some use cases, the physical body of an audio device, and/or active noise cancellation operations can also block or cancel ambient sounds that the user may desire to hear. These desirable ambient sounds may include the sound of a voice of a person having a conversation with the user, an alert or notification sound, or the like. Some electronic devices can generate, from the audio signal from a microphone, a pass-through audio signal that includes some or all of the ambient sounds in the audio signal (e.g., in order to allow the user to hear the surrounding environment as if the audio device were not present).

Aspects of the subject technology may provide an adjustable headphone/earbud pass-through signal with a flat frequency response at various adjusted levels. This can be achieved by mixing a pass-through audio signal with an active noise cancellation (ANC) signal according to a mixing curve that defines a mixing value as a function of the ambient sound level. The mixing curve can be different for different operational states of a device. The different operational states can include operational modes of the device itself (e.g., telephony, conversation, downlink), environmental conditions (e.g., stationary noise, such as in an airplane) in an physical environment of the device, and/or user states (e.g., motion states of the user of the device, such as walking or running while carrying/wearying a device). When multiple operational states are present, a priority table can be use select the mixing curve.

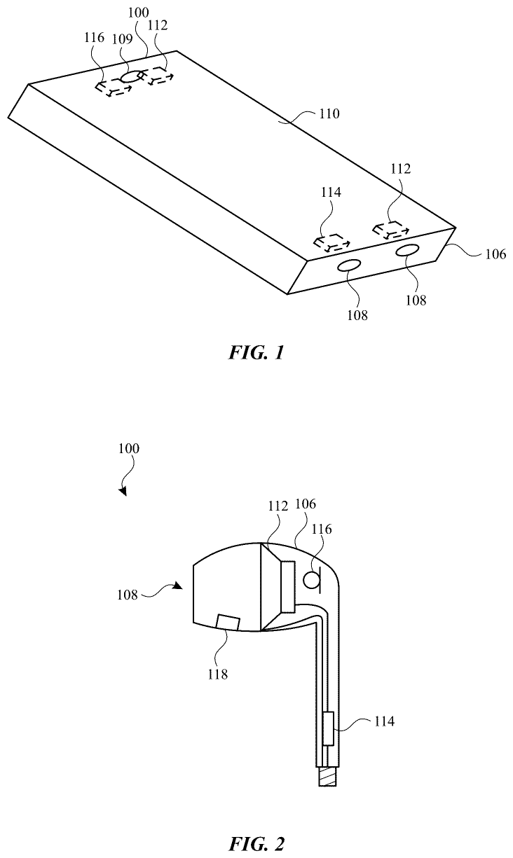

FIG. 1 illustrates an example electronic device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, electronic device 100 has been implemented using a housing 106 that is sufficiently small to be portable and carried or worn by a user (e.g., electronic device 100 of FIG. 1 may be a handheld electronic device such as a tablet computer or a cellular telephone or smart phone or a wearable device such as a smart watch, a pendant device, a head mountable device, or the like). In the example of FIG. 1, electronic device 100 includes a display such as display 110 mounted on the front of a housing 106. However, in other implementations, the electronic device 100 may be provided without a display. Electronic device 100 may include one or more input/output devices such as a touch screen incorporated into display 110, a button, a switch, a dial, a crown, a touch sensor, an ultrasonic sensor, and/or other input output components disposed on or behind display 110 or on or behind other portions of housing 106. Display 110 and/or housing 106 may include one or more openings to accommodate a button, a speaker, a light source, or a camera (as examples).

In the example of FIG. 1, housing 106 includes openings 108. For example, openings 108 may form one or more respective ports for one or more respective audio components. In the example of FIG. 1, the electronic device 100 includes an opening 108 that forms a speaker port for a speaker 112 disposed within the housing 106, and another opening 108 that forms a microphone port for a microphone 114 disposed within the housing 106.

In the example of FIG. 1, display 110 also includes an opening 109. For example, opening 109 may form a port for one or more additional audio components. In the example of FIG. 1, the opening 109 forms a speaker port for another speaker 112 and a microphone port for a microphone 116 disposed within the housing 106 and behind a portion of the display 110. Although two microphones are depicted in FIG. 1, it is appreciated that the electronic device 100 may include one or more additional microphones, such as an error microphone positioned between a speaker, such as the speaker 112 mounted behind the display 110 and the port for that speaker.

In one or more use cases, one or more of the speakers 112 may generate a speaker output based, for example, on a downlink communications signal or a device-generated or streaming audio signal. In one or more implementations, the speaker(s) 112 may be driven by an output downlink signal that includes far-end acoustic signal components from a remote device. In one or more use cases, while a near-end user is using the electronic device 100 to input and/or transmit their own speech, ambient noise surrounding the user may also be present in the environment around the electronic device. Thus, the microphones 114 and 116 may capture the user's own speech as well as the ambient sounds around the electronic device 100.

In various implementations, the housing 106 and/or the display 110 may also include other openings, such as openings for one or more microphones, one or more pressure sensors, one or more light sources, or other components that receive or provide signals from or to the environment external to the housing 106. Openings such as openings 108 and/or opening 109 may be open ports or may be completely or partially covered with a permeable membrane or a mesh structure that allows air and/or sound to pass through the openings. Although three openings (e.g., two openings 108 and one opening 109) are shown in FIG. 1, this is merely illustrative. One opening 108, two openings 108, or more than two openings 108 may be provided on the one or more sidewalls of the housing 106, on a rear surface of housing 106 and/or a front surface of housing 106. One opening 109, two openings 109, or more than two openings 109 may be provided in the display 110. In some implementations, one or more groups of openings 108 in housing 106 and/or groups of openings 109 in display 110 may be aligned with a single port of an audio component within housing 106. Housing 106, which may sometimes be referred to as a case, may be formed of plastic, glass, ceramics, fiber composites, metal (e.g., stainless steel, aluminum, etc.), other suitable materials, or a combination of any two or more of these materials. The electronic device 100 also includes additional components such as processing circuitry (e.g., one or more processors), memory, a power source such as a battery, communications circuitry, and the like.

The configuration of electronic device 100 of FIG. 1 is merely illustrative. In other implementations, electronic device 100 may be a computer such as a computer that is integrated into a display such as a computer monitor, a laptop computer, a media player, a gaming device, a navigation device, a computer monitor, a television, a headphone, an earbud, or other electronic equipment. As discussed herein, in some implementations, electronic device 100 may be provided in the form of a smart phone. In one or more implementations, housing 106 may include one or more interfaces for mechanically coupling housing 106 to a strap or other structure for securing housing 106 to a wearer.

FIG. 2 illustrates another exemplary implementation of the electronic device 100, in which the aspects of the subject technology described herein may be implemented. Specifically, FIG. 2 illustrates an example of the electronic device 100 implemented as an earbud. In this example, the housing 106 is shaped for seating in the user's concha and for interfacing with the user's ear canal. In one or more implementations, the earbud of FIG. 2 may include processing circuitry that performs one or more of the operations described herein. In one or more other implementations, the earbud of FIG. 2 may be used in conjunction with another electronic device, such as a smartphone or tablet computer to which microphone signals received by microphones 114, 116, and/or 118 are transmitted and/or from which audio output signals for the speaker 112 are received.

Aspects of the subject technology described herein may be performed by one or more processors of the earbud of FIG. 2 and/or may be performed by a processor inside a smartphone or tablet computer, upon receiving the microphone signals from a wired or wireless data communication link with the earbud of FIG. 2. The electronic device 100 in the example of FIG. 2 may include communications circuitry for communicating with one or more other electronic devices via a wired or wireless connection. In use, microphones 114, 116, and/or 118 in the earbud may receive ambient sounds in the physical environment of the electronic device 100. The earbud of FIG. 2 may be one of a pair of earbuds for a user's two ears. However, it is also understood that single earpiece or monaural headsets may also be used. Although an example is shown in FIG. 2 in which the electronic device 100 is implemented as an earbud, in other implementations, the electronic device 100 may be implemented as headphones including a pair of earcups that are configured to be placed over the user's ears. Further, the earbuds may be wired earbuds or untethered wireless earbuds that communicate with each other and with an external device such as a smartphone or a tablet computer via Bluetooth™ signals.

In the example of FIG. 2, the electronic device 100 includes a speaker 112, a top microphone (e.g., microphone 116) whose sound sensitive surface faces a direction that is opposite the eardrum of the user when the earbud is worn, a bottom microphone (e.g., microphone 114) that is located in or near an end portion of the housing 106 of the earbud where it is the closest microphone to the user's mouth, and an error microphone 118 that senses the sound at or near the user's eardrum (e.g., in the user's ear canal). In the example of FIG. 2, the error microphone 118 may be in a position and orientation to receive an output from the speaker 112 and/or one or more ambient sounds (e.g., ambient noise, voices of people other than the user of the electronic device 100, a voice of the user of the electronic device 100, or the like) that leak past the housing 106 to reach the error microphone 118.

In one or more implementations, the top and bottom microphones of FIG. 2 can be used as, or as part of, a microphone array for purposes of pickup beamforming. More specifically, the microphone arrays may be used to create microphone array beams which can be steered to a given direction by emphasizing and deemphasizing selected top and bottom microphones (e.g., to enhance pick up of the user's voice from the direction of their mouth or another sound in the physical environment). Similarly, the microphone array beamforming can also be configured to exhibit or provide pickup nulls in other given directions, to suppress pickup of an ambient noise source. Accordingly, the beamforming process, also referred to as spatial filtering, may be a signal processing technique using the microphone array for directional sound reception.

In one or more implementations, when the electronic device 100 is implemented as an earbud as in FIG. 2, the electronic device 100 may include a battery device, one or more processors, and a communication interface (not shown). The processors of the earbud may be a digital signal processing chip that processes an audio signal(s) (e.g., microphone signal(s)) from at least one of the microphones 114, 116, and/or 118. The communication interface may include a Bluetooth™ receiver and transmitter to communicate acoustic signals from the microphones 114, 116, and/or 118 in both directions (uplink and downlink), with an external device such as a smartphone or a tablet computer, in some implementations.

As is discussed in further detail below, microphones 114, 116, and/or 118, and/or other microphones and/or sensors of the electronic device 100 may be used, in conjunction with the architectures/components described herein, for automatic adaptive noise cancellation.

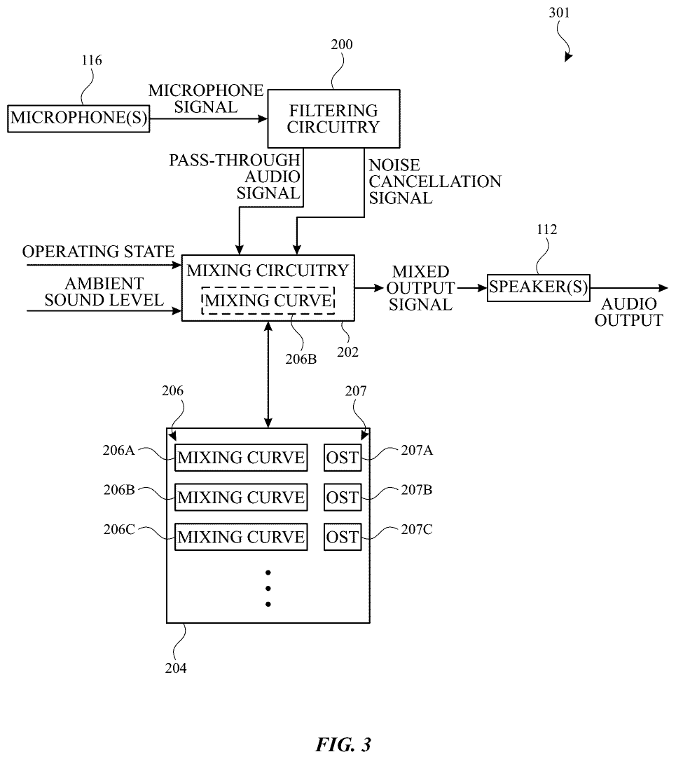

For example, FIG. 3 illustrates a high-level block diagram of an example architecture 301 that may be implemented in the electronic device 100 to provide automatic adaptive noise cancellation capabilities, in accordance with various aspects of the subject technology. In the example of FIG. 3, the architecture 301 includes one or more microphones 116, processing circuitry including filtering circuitry 200 and mixing circuitry 202, one or more speakers 112, and memory 204.

As shown, a microphone signal from one or more microphones 116 may be provided to the filtering circuitry 200. The microphone signal may be provided directly from the microphone 116 to the filtering circuitry 200, or a microphone signal received by the microphone 116 may be pre-processed prior to providing the microphone signal to the filtering circuitry 200. The microphone signal may include representations of one or more sounds (e.g., ambient sounds) from the physical environment around the electronic device 100.

As shown, the filtering circuitry 200 may generate, based on the microphone signal, a pass-through audio signal (e.g., a transparency signal) and a noise cancellation signal. For example, the pass-through audio signal may include some or all of the ambient sounds that were included in the microphone signal. For example, the noise cancellation signal may be an anti-noise signal that is configured to destructively interfere with a portion of the one or more sounds from physical environment that reach the user's ear (e.g., past any physical blockage of the one or more sounds by the housing 106 of the electronic device 100).

As shown, the pass-through audio signal and the noise cancellation signal may be provided to the mixing circuitry 202. As shown, the mixing circuitry 202 may also receive an operational state of the electronic device 100. The mixing circuitry 202 may also receive a sound level. For example, the sound level may be a current ambient sound level (e.g., sound pressure level, or SPL) in the physical environment of the electronic device 100.

As shown in FIG. 3, the electronic device 100 may include memory 204 that stores one or more mixing curves 206. As shown, each of the mixing curves 206 may be stored in connection with a corresponding operational state 207. In the example of FIG. 3, the memory 204 stores a mixing curve 206A associated with an operational state 207A, a mixing curve 206B associated with an operational state 207B, and a mixing curve 206C associated with an operational state 207C. In the example of FIG. 3, the mixing circuitry 202 may obtain, from the memory 204, the mixing curve 206B from among the mixing curves 206 stored in the memory 204. For example, the mixing circuitry 202 may obtain the mixing curve 206B based on the operational state of the electronic device 100 (e.g., by determining that the current operational state of the electronic device 100 corresponds to the operational state 207B). As discussed in further detail hereinafter, each of the mixing curves 206 may be a function of the ambient sound level. For example, the mixing curve 206B may provide, for each ambient sound level in a range of ambient sound levels, a mixing factor. For example, the mixing factor may correspond to a ratio of the pass-through audio signal to the noise cancellation signal in a mixed output signal that includes variable amounts of the pass-through audio signal and the noise cancellation signal.

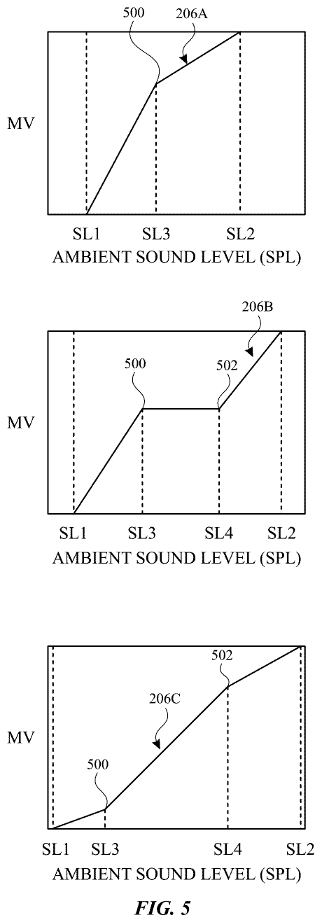

The mixing curves 206 may include linear functions of the ambient sound level, non-linear functions of the ambient sound level, piecewise-defined functions of the ambient sound level, functions of the ambient sound level having one or more inflections points at which the rate of change of the mixing curve changes, monotonically increasing functions of the ambient sound level, functions of the ambient sound level with increasing portions and decreasing portions, and/or any other suitable function of the ambient sound level that are specific to an operational state of an electronic device, illustrative examples of which are described hereinafter in connection with FIG. 5.

As illustrated by the example of FIG. 3, the mixing circuitry 202 may receive an operational state of the electronic device 100, obtain the mixing curve 206B from among the mixing curves 206 based on the operational state, obtain a mixing value from the mixing curve 206B using the received ambient sound level, and generate a mixed output signal by mixing the pass-through audio signal and the noise cancelling signal with a mixing ratio defined by the mixing factor.

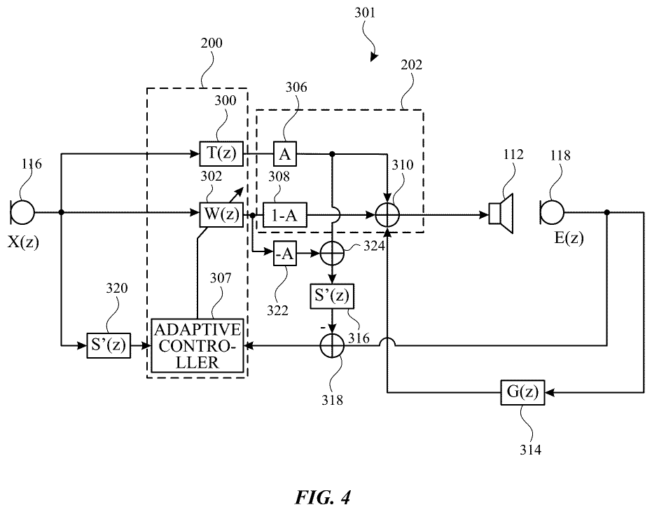

FIG. 4 illustrates additional details that may be included in the architecture of FIG. 3. For example, as shown in FIG. 4, the filtering circuitry 200 may include an active noise cancellation (ANC) filter 302 and a pass-through filter 300. As shown, the mixing circuitry 202 may include a gain stage 306, a gain stage 308, and an adder 310. As shown in FIG. 4, the pass-through filter may be configured to receive a microphone signal from the microphone 116, generate the pass-through audio signal based on the microphone signal, and provide the pass-through audio signal to a gain stage 306. For example, the pass-through filter 300 may be configured to generate the pass-through audio signal to include representations of any sounds from the physical environment that are being physically blocked by the housing of the electronic device 100 from reaching the ear of the user (e.g., so that the user can experience the acoustic environment as though not wearing or using the electronic device 100). As examples, the pass-through filter 300 may be implemented as a finite impulse response (FIR), an infinite impulse response (IIR), or other analog or digital filter having a transfer function which, when the result is output by the speaker 112, causes the output of the speaker 112 to match the input to the microphone 116 (e.g., as though the electronic device 100 is acoustically transparent).

As shown, the ANC filter 302 may generate the noise cancellation signal, and provide the noise cancellation signal to a gain stage 308. In one or more implementations, the ANC filter 302 may include a variation of an optimal filter that can produce an estimate of the ambient sounds by filtering a microphone signal corresponding to the microphone 116 (e.g., an audio signal received directly from the microphone 116 or an audio signal received by the microphone 116 and pre-processed prior to providing the audio signal to the filtering circuitry 200) and can generate a noise cancellation signal (e.g., an anti-noise signal) corresponding to that estimate. For example, an estimate of the ambient sound(s) and a corresponding noise cancellation signal (e.g., anti-noise signal) can be produced, for example, by adaptive prediction and/or by using a prediction filter that exploits a low-pass characteristic of the audio signal. The noise cancellation signal generated by the ANC filter 302 may be adjusted by the gain stage 308 and mixed (e.g., by an adder 310) with the output of the gain stage 306, before the mixed output signal is provided, from the adder 310, for output by the speaker 112. In one or more implementations, the ANC filter 302 and/or the pass-through filter 300 can be implemented at least partially in hardware, firmware or software.

As shown in FIG. 4, the gain stage 306 may apply a gain, A, to the pass-through audio signal that is generated by the pass-through filter 300. As shown, the gain stage 308 may apply a gain corresponding to a complement (e.g., 1-A) of the gain, A, to the noise cancellation signal generated by the ANC filter 302. For example, the gain, (1-A), that is applied to the noise cancellation signal may be a mixing value that is obtained from the mixing curve 206B of FIG. 3 using the current ambient sound level in the physical environment around the electronic device (e.g., as determined from the microphone signal from the microphone 116). In this way, the mixing value (e.g., (1-A)) can be adjusted to control the ratio of the pass-through audio signal to the noise cancellation signal in the mixed output signal that is provided, by the adder 310, to the speaker 112. In this way, the mixing value (e.g., (1-A)) can help control the eardrum sound pressure level at or near the eardrum of the user of the electronic device 100 (e.g., by decreasing A (and resultantly increasing (1-A)) to cause more of the noise cancellation signal, relative to the pass-through audio signal, in the mixed output signal, or increasing A (and resultantly decreasing (1-A)) to cause more of the pass-through audio signal, relative to the noise cancellation signal, in the mixed output signal).

In other implementations, the amount of noise cancellation could be adjusted simply by adjusting the gain applied to the noise cancellation signal and not including any pass-through audio signal from a pass-through filter 300. However, it has been determined that the frequency response of such a ANC-only approach may not be flat through the gain adjustments. By mixing the amount of the pass-through audio signal and the noise cancellation signal as described herein, the amount of noise cancellation at the user's ear can be controlled while keeping the frequency response substantially flat across the various amounts of noise cancellation.

FIG. 4 also illustrates other aspects of the circuitry that can be provided to generate the noise cancellation signal from the ANC filter 302 (e.g., in a way that is compatible with the addition of the pass-through audio signal into the mixed output signal). For example, as shown in FIG. 4, the electronic device 100 may include an adaptive controller 307. As illustrated in FIG. 4, the ANC filter 302 may generate a noise cancellation (e.g., anti-noise) signal that, when output by the speaker 112, destructively interferes with ambient sound that leaks past the housing 106 and into the user's ear canal. The leaked ambient noise and the noise cancellation portion of the output of the speaker 112 (based on some or all of the noise cancellation signal generated by the ANC filter 302 and included in the mixed output signal by the mixing circuitry 202) may be combined acoustically in the user's ear canal, intentionally in a destructive manner so as to result in a very small residual noise or error. As shown, the error microphone 118 may receive this residual noise or error (e.g., in addition to any user audio content, such as a voice or video call or a one-way digital media streaming or playback session) that is being simultaneously output by the speaker 112, and may provide an error signal to a feedback noise filter 314. As shown, in one or more implementations, the feedback noise filter 314 may generate an anti-residual noise signal that can be mixed into the mixed output signal by the adder 310.

In the example of FIG. 4, the ANC filter 302 may be adaptively controlled by the adaptive controller 307 (e.g., which may be implemented as a coefficient generator for the ANC filter 302). As shown, the adaptive controller 307 may receive a first input (e.g., a feedback signal) that is based on the error signal from the error microphone 118, and a second input that is based on the microphone signal from the microphone 116. For example, the second input may be the microphone signal from the microphone 116, filtered by a modeling filter 320 (e.g., a secondary path modeling filter). As shown, the error signal from the error microphone 118 may be differenced (e.g., by adder 318) with a mixed internal signal from a modeling filter 316 (e.g., a secondary path modeling filter). For example, the modeling filter 316 may receive a combination of the output of the gain stage 306 (e.g., the pass-through audio signal) and an output of a gain stage 322. For example, the gain stage 322 may apply a gain corresponding to a negative of the gain, A, to the output of the ANC filter 302, and provide the resulting signal to the adder 324 for combination (e.g., differencing) with the pass-through audio signal from the gain stage 306.

These first and second input signals may be used by the adaptive controller 307 (e.g., in accordance with a filtered-x, least mean squares (FXLMS) operation), to estimate, for example, primary and secondary path transfer functions. The ANC filter 302 may be an adaptive filter that operates using coefficients that are repeatedly or continually being updated by the adaptive controller 307 so as to drive the error signal from the error microphone 118 to a minimum. It is also appreciated that other adaptive filter algorithms can be used by the adaptive controller 307, including adaptive filter algorithms (e.g., frequency domain adaptive filters (FDAFs)) that use different adaptive filter controllers. When the electronic device is outputting some or all of the noise cancelling signal from the ANC filter 302, the adaptive controller 307 may perform computations that (e.g., continually) adjust or update filter coefficients of the ANC filter 302, in order to adapt the noise cancellation signal to the changing ambient noise and acoustic load seen by the microphone 116 while the user is using the electronic device 100. As one illustrative example of how the filter coefficients can be updated, the adaptive controller 307 may implement a leaky, least mean squares (LMS) adaptive algorithm in which a current coefficient is computed based on weighting a prior coefficient. In one or more implementations, the gain stage 322, the adder 324, the modeling filter 316, and the adder 318 can facilitate the use of adaptive noise cancellation in combination with a pass-through signal, as described herein.

As discussed herein, the gain, A, and/or the complement, (1-A), may be determined by a mixing factor that is obtained from a mixing curve 206 (e.g., the complement, 1-A, may be set to the mixing value in some implementations). FIG. 5 illustrates examples of mixing curves from which the mixing factor (and resultingly the gain, A, and its complement) can be obtained. In the example of FIG. 5, three example mixing curves are shown. For example, each of the mixing curves shown in FIG. 5 may correspond to a particular operational state 207 of the electronic device 100. For example, the mixing curve 206A may be used to obtain a mixing value for a current ambient sound level when the electronic device 100 is in a telephony mode (e.g., when the user of the electronic device 100 is conducting a telephone conversation, an audio conference, or a video conference with audio, using the electronic device 100), the mixing curve 206B may be used to obtain a mixing value for a current ambient sound level when the user of the electronic device 100 is engaged in a conversation with a person in the physical environment of the electronic device 100, and the mixing curve 206C may be used to obtain a mixing value for a current ambient sound level when the user of the electronic device 100 is walking or running while wearing or carrying the electronic device 100.

However, these three examples of mixing curves and corresponding operational states are merely illustrative, and other mixing curves can be provided for other operational states. In various examples, the operational states may include an operational mode of the electronic device 100 itself (e.g., a telephony mode, a downlink mode, an audio playback mode, or the like), a state of the user of the electronic device 100 (e.g., an in-conversation state, or a motion states, such as a walking state or a running state), or an environmental condition in a physical environment around the electronic device 100 (e.g., a noise condition, such as a stationary noise state, a dynamic noise state, an airplane noise state, a vehicle noise state, a street noise state, a train noise state, and/or other noise state).

In one or more use cases, the electronic device may detect more than one concurrent operational state. For example, the electronic device may determine that the user of the electronic device is engaged in a conversation while walking in a street noise environment. As another example, the electronic device 100 may determine that the electronic device 100 is in a telephony mode while in a stationary noise environment. As another example, the electronic device 100 may determine that the electronic device 100 is in an audio playback mode while in a stationary noise environment. In one or more implementations, the electronic device 100 may store a priority list that can be used to select a mixing curve 206 that corresponds to a particular operational state 207, in a use case in which multiple operational states 207 are concurrently detected.

In one illustrative example, a telephony mode of the electronic device 100 may have a higher priority than a conversation mode of the user of the electronic device 100. In another illustrative example, the telephony mode of the electronic device 100 may have a priority that is higher than a walking or running mode of the user of the electronic device 100. As another illustrative example, a conversation mode of the user of the electronic device 100 may have a higher priority than an audio output mode of the electronic device 100. As another illustrative example, the telephony mode of the electronic device 100 may have a higher priority than a stationary noise state of the physical environment. In one or more implementations, when multiple operational states of the electronic device are detected concurrently, the priority list may be used to select the mixing curve of the detected operational state having the highest priority in the priority list. In one or more other implementations, mixing curves for two or more operational states may be combined when the two or more operational states are concurrently detected, and/or one or more mixing curves can be provided for one or more respective specific combinations of operational states.

FIG. 5 also illustrates various aspects of the various mixing curves 206 that can be set for a particular operational mode, in order to control the amount of mixing of the pass-through audio signal and the noise cancellation signal for any given value of the ambient sound level that may occur while the electronic device 100 is in that particular operational mode. For example, in the example of FIG. 5, the mixing curve 206A defines a first ambient sound level (SL1) below which only the pass-through audio signal is used in the mixed output signal (e.g., the mixing value, MV, corresponding to (1-A), is zero, and the gain, A, is one) and a second ambient sound level (e.g., SL2) above which only the noise cancellation signal is used in the mixed output signal (e.g., the mixing value, MV, corresponding to (1-A), is one, and the gain, A, is zero). In this example, the mixing curve 206A further defines a variable amount of mixing of the pass-through audio signal and the noise cancellation signal for ambient sound levels between the first ambient sound level (SL1) and the second ambient sound level (SL2). As shown, variable amount of mixing for the ambient sound levels between the first ambient sound level and the second ambient sound level may include a first variation that changes at a first rate for ambient sound levels between the first ambient sound level (SL1) and an inflection point 500 (e.g., at an ambient sound level, SL3), and a second variation that changes a second rate for ambient sound levels between the inflection point 500 and the second ambient sound level (SL2). In the example of FIG. 5, the first rate of variation (e.g., the slope of the mixing curve 206A below the inflection point 500) is greater than the second rate of variation (e.g., the slope of the mixing curve 206A above the inflection point 500).

As shown in FIG. 5, each of the mixing curves 206B and 206C also includes a first ambient sound level (SL1) below which only the pass-through audio signal is used in the mixed output signal, a second ambient sound level (e.g., SL2) above which only the noise cancellation signal is used in the mixed output signal, and a variable amount of mixing of the pass-through audio signal and the noise cancellation signal for ambient sound levels between the first ambient sound level (SL1) and the second ambient sound level (SL2). However, as shown, the first ambient sound level (SL1), the second ambient sound level (SL2), and the sound level, SL3, at the inflection point 500 are different for each different mixing curve. As shown, the rates of change between the sound levels SL1, SL2, and SL3 are also different for the different mixing curves. In this way, the variations in the mixing curves 206 can provide varying amounts of mixings of the pass-through audio signal and the noise cancellation signal in the mixed output signal, for various different operational states of the electronic device 100. More specifically, a particular ambient sound level that results in a particular mixing value MV when using the mixing curve 206A will result in a different mixing value MV when using the mixing curve 206B or the mixing curve 206C, even if the ambient sound level has not changed.

For example, while in one operational state, the electronic device 100 may dynamically adjust the mix of the pass-through audio signal and the noise cancellation signal in the mixed output signal by obtaining, at a first time, a first measure of the current ambient sound level; generating, at substantially the first time, the mixed output signal by obtaining the mixing value, MV, from the mixing curve 206A based on the first measure of the current ambient sound level; obtain, at a second time, a second measure of the current ambient sound level (e.g., following a change in the ambient sound in the physical environment); and generate, at substantially the second time, the mixed output signal by obtaining the mixing value, MV, from the mixing curve 206A based on the second measure of the current ambient sound level. At a later time, the electronic device 100 may detect a change in the operational state of the device; obtain, based on detected change in the operational state, the mixing curve 206B; and dynamically adjust the mix of the pass-through audio signal and the noise cancellation signal in the mixed output signal, based on a different mixing value, MV, obtained, from the mixing curve 206B, using a third measure of the current ambient sound level (e.g., which may be the same as or different from the second measure of the current ambient sound level).

In the example of FIG. 5, each of the mixing curves 206B and 206C also includes a second inflection point 502 (e.g., at an ambient sound level, SL4) at which the rate of change of the mixing value changes. For example, the inflection point 500 may be a first inflection point, and the second variation that changes at the second rate for ambient sound levels between the inflection point 500 and the second ambient sound level (SL2) may be a first portion of the second variation. In this example, a second portion of the second variation may change at a third rate (e.g., a third slope of the mixing curve 206B or the mixing curve 206C) for ambient sound levels between the second inflection point 502 and the second ambient sound level (SL2). As shown, the locations of the inflection point 500 and the second inflection point 502 are different for the mixing curve 206B and the mixing curve 206C. Although one or two inflection points are shown in the examples of FIG. 5, it is appreciated that one, two, or more than two inflection points may be included in a mixing curve, and that one or more mixing curves may include increasing and/or decreasing portions, and/or rate changes that occur smoothly (e.g., rather than at a single inflection point).

In one or more implementations, the mixing curves 206 (e.g., including the mixing curve 206A, the mixing curve 206B, and the mixing curve 206C) may be generated empirically and deterministically for each operational state to provide a desired mixed output signal. In one or more other implementations, the mixing curves 206 (e.g., including the mixing curve 206A, the mixing curve 206B, and the mixing curve 206C) may be learned by training a machine learning model (e.g., by adjusting one or more weights and/or other parameters of the machine learning model during a training operation) to output mixing curves based on training ambient sound levels and training output mixing values. In one or more implementations, operational states may be deterministically defined and detected in a rules-based detection process. In one or more other implementations, the operational states may be detected by one or more machine learning models that have been trained (e.g., by adjusting one or more weights and/or other parameters of the machine learning model(s) during a training operation) to output an operational state based on training audio input data, training input device sensor (e.g., IMU) data, based on training input device operational data, and/or training output operational states.

In the examples described herein in connection with FIGS. 3-5, once a mixing value has been obtained (e.g., from the mixing curve selected according to the current operational state of a device, and based on a selection of the mixing value from the selected mixing curve using the current ambient sound level), a gain (e.g., A) that is derived from the mixing value is applied to a pass-through audio signal (e.g., from the pass-through filter 300). In these examples, a single gain across all frequencies of the pass-through signal has been described. However, in one or more implementations, the mixing curve may be determined based on the operating state of the device and based on a user input (e.g., a user input indicating a user preference for an amount of noise cancellation). Further, in one or more implementations, the gain that is applied to the pass-through audio signal may vary with frequency in a way that depends on the amount of noise cancellation being performed (e.g., based on the mixing value).

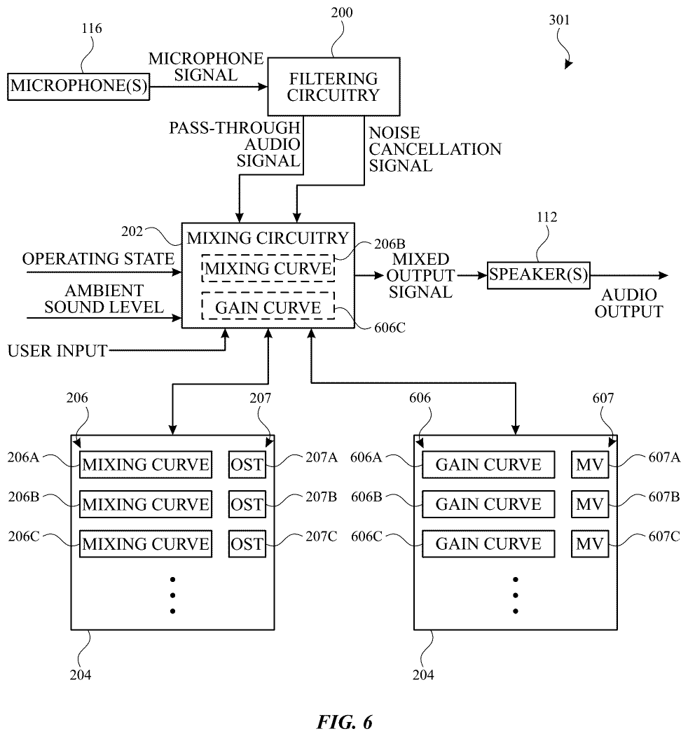

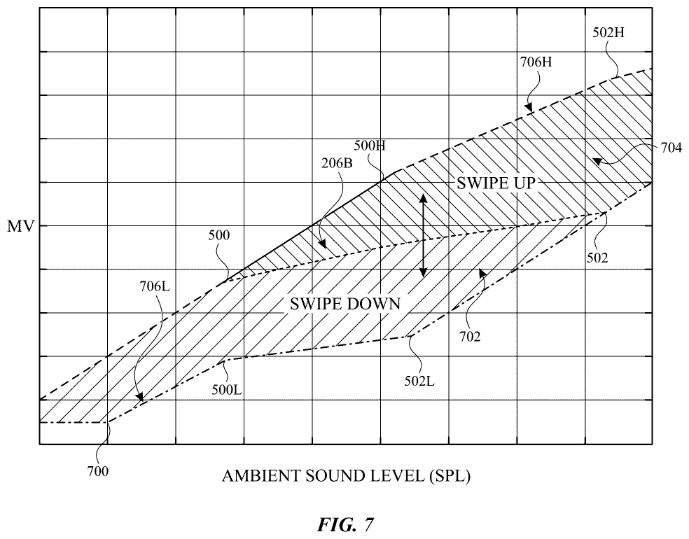

For example, FIG. 6 illustrates the example architecture 301 of FIG. 3, for providing automatic adaptive noise cancellation capabilities, in an implementation in which the mixing curve may be determined based on the operating state of the device and based on a user input, and in which the gain that is applied to the pass-through audio signal may vary with frequency in a way that depends on the ambient sound level (e.g., and/or on the mixing value). As shown in the example of FIG. 6, in addition to an operating state and an ambient sound level, the mixing circuitry 202 may receive a user input. For example, the user input may be a user preference that indicates an amount of ambient noise is desired by the user. In one example implementation, the user input may be the mixing value (e.g., the user may be provided with a slider or other user input element for directly adjusting the mixing value). However, for improved audio performance, the user input may be applied by the mixing circuitry 202 to modify a mixing curve (e.g., as discussed herein in connection with FIGS. 7-9) that has been selected based on the operating state of the device, and the mixing circuitry may then obtain the mixing value from the modified mixing curve.

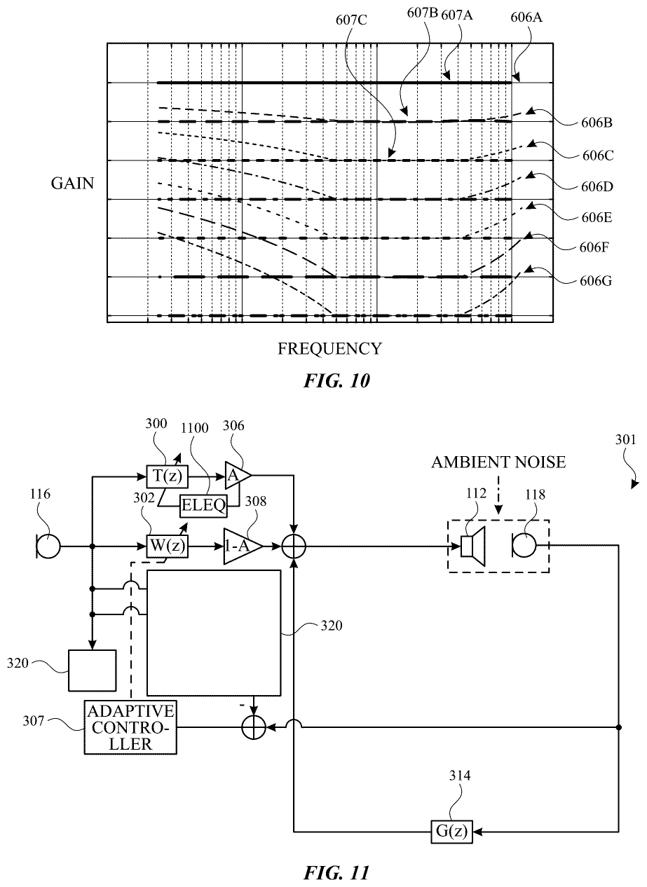

As illustrated in FIG. 6, once the mixing value has been obtained (e.g., from a mixing curve that has been modified based on a user input or that is unmodified), the mixing circuitry may obtain a gain curve 606 based on the mixing value (e.g., a mixing value 607 in the example of FIG. 6). In the example, of FIG. 6, the mixing circuitry 202 has obtained a gain curve 606C based on a mixing value 607C (e.g., obtained by extracting the mixing value that corresponds to the ambient sound level from the selected mixing curve 206B), from among multiple gain curves (e.g., gain curves 606A, 606B, 606C, etc.) that are each stored in association with a corresponding mixing value (e.g., mixing values 607A, 607B, 607C, etc.). For example, each of the gain curves 606A, 606B, 606C, etc. may identify several different gains (e.g., A) to be applied to the pass-through audio signal at each of several different corresponding frequencies (e.g., as discussed in further detail hereinafter in connection with FIGS. 10-12). It is appreciated that the gain curve may be selected based on a mixing value (e.g., an amount of noise cancellation), but not necessarily based on the mixing curve (e.g., because the same mixing value can be obtained, at various different times from various different mixing curves having various different mixing values for the same ambient sound level, if the ambient sound level changes). It is also appreciated that, rather than storing a set of gain curves each in association with a mixing value as in the illustrative example of FIG. 6, the gain curves can be obtained from a mixing value in other ways (e.g., by providing the mixing value into a computation from which the gain curve is derived, or by providing the mixing value to a machine learning model that has been trained to provide a gain curve based on a mixing value).

As discussed above in connection with FIG. 6, in one or more implementation, a mixing curve may be modified based on a user input. For example, FIG. 7 illustrates an example of a mixing curve being modified based on a user input. As one illustrative example, FIG. 7 depicts a range 702 below the mixing curve 206B within which the mixing curve 206B may be modified by a user preference for less noise (e.g., responsive to a swipe down or other input indicating a preference for less noise by a user). FIG. 7 also illustrates a range 704 above the mixing curve 206B within which the mixing curve 206B may be modified by user preference for more noise or more transparency (e.g., responsive to a swipe up or other input indicating a preference for more noise or more transparency by a user). In this example, the mixing curve 206B (e.g., selected based on an operating state of the electronic device 100) may be modified between a lower limit mixing curve 706L and an upper limit mixing curve 706H that have been defined for the mixing curve 206B. Other mixing curves may have different lower and/or upper limits and/or different ranges within which those mixing curves can be modified.

As discussed herein, a mixing curve such as the mixing curve 206B may include inflection points such as the inflection point 500 and the inflection point 502. As shown in FIG. 7, modifying the mixing curve based on a user input may include modifying the locations of the inflection points. For example, the lower limit mixing curve 706L may have inflection points 500L and 502L at different ambient sound levels from the inflection points 500 and 502 of the unmodified mixing curve 206B, and the upper limit mixing curve 706H may have inflection points 500H and 502H at different ambient sound levels from the inflection points 500 and 502 of the unmodified mixing curve 206B and different ambient sound levels from the inflection points 500L and 502L of the lower limit mixing curve 706L. In this example, the lower limit mixing curve 706L includes an additional inflection point 700 that is not included in the unmodified mixing curve 206B or the upper limit mixing curve 706H.

In one or more implementations, the mixing curve 206B may be continuously modifiable within the ranges 702 and 704 between the lower limit mixing curve 706L and the upper limit mixing curve 706H (e.g., based on a continuously variable user input, such as a user input to a slider or a turn or a dial with a range between zero and one hundred percent). In one or more other implementations, an electronic device, such as the electronic device 100 may provide a user with a set of discrete user input options, and the mixing curves may be modified between a set of predetermined discrete mixing curve modifications.

For example, FIG. 8 illustrates an example of a user interface 800 that may be provided for a user (e.g., displayed by a display of an electronic device, such as the electronic device 100). In the example of FIG. 8, the user interface 800 includes a slider 802. In this example, the slider 802 can be moved by a user between three discrete options. As examples, the options may include a “less noise” option 804, a “default” or “neutral” option 806, and a “more noise” or “more transparency” option 806.

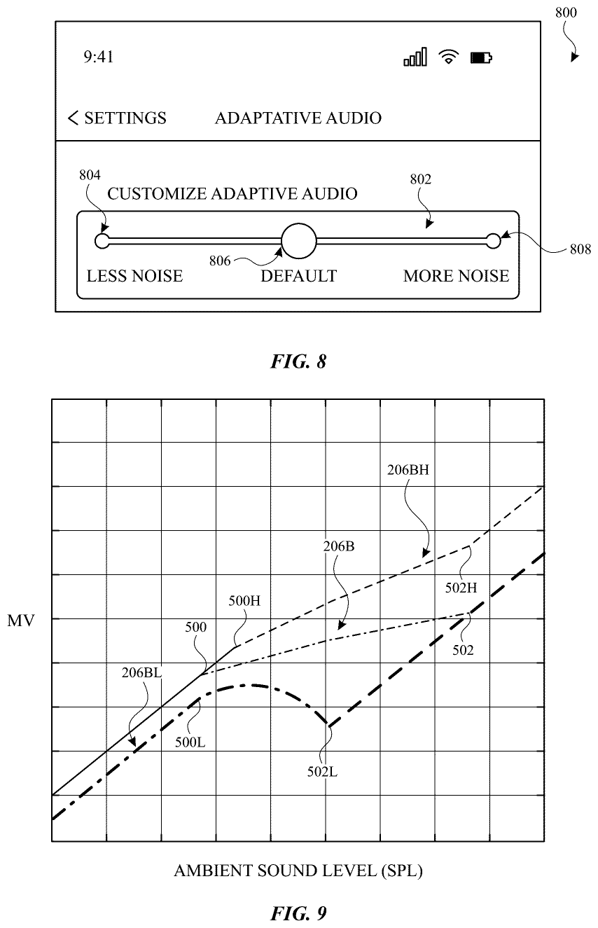

FIG. 9 illustrates examples of mixing curves that may result from user selections of the options 804, 806, and 808 of FIG. 8 in one or more implementations. For example, when the slider 802 of the user interface 800 is set to select the option 806, the mixing curve may be the unmodified mixing curve selected by the mixing circuitry 222 based on the operational state of the device (e.g., the mixing curve 206B in various examples discussed herein). FIG. 9 illustrates how moving the slider 802 to the “less noise” option 804 of FIG. 8 may result in modifying the mixing curve 206B to the modified mixing curve 206BL (e.g., with a different rate of change, a different inflection point 500L and/or a different inflection point 502L). Moving the slider 802 to the “more noise” option 804 of FIG. 8 may result in modifying the mixing curve 206B to the modified mixing curve 206BH (e.g., with a different rate of change, a different inflection point 500H, and/or a different inflection point 502H). As shown in FIG. 9, in one or more implementations, a modified mixing curve may have a non-linear rate of change, and/or may increase or decrease with increasing ambient sound level.

FIG. 10 illustrates examples of various gain curves as described herein (e.g., gain curves that may be applied to the pass-through audio signal generated by the pass-through filter 300 or implemented as modifications to the pass-through filter 300). As shown in FIG. 10, gain curves 606, such as gain curves 606A, 606B, 606C, 606D, 606E, 606F, and 606G may each identify several different gains (e.g., (f)) for the pass-through audio signal at each of several different corresponding frequencies. For example, the mixing values 607 (e.g., mixing values 607A, 607B, 607C, etc.) obtained from a selected (e.g., modified or unmodified) mixing curve may determine the gain for the pass-through signal within a central frequency band (e.g., a frequency band between five hundred Hz and three kHz and including a central frequency fc). In one or more implementations, when a zero gain (e.g., 1-A(fc)=zero, when A(fc)=1) is applied to the noise cancellation signal, a gain curve 606A for the pass-through signal may be flat across all frequencies. As shown in FIG. 10, as the gain (e.g., 1-A(fc)) that applied to the noise cancellation signal increases (e.g., as A(fc) decreases), the gain curves 606B, 606C, 606D, etc. may define increasing gains A(f) for the pass-through signal at frequencies, f, above and below the central frequency range.

For example, in an implementation in which the gain curves 606 are not used (e.g., if a single gain, A, is applied across all frequencies of the pass-through signal), this flat attenuation may make the low frequency (e.g., below 300 Hz) and high frequency (e.g., above 6 kHz) components of environmental sounds less audible to a user, because the human ear has less sensitivity at these frequencies when the overall sound level drops (e.g., due to an actual decrease on the overall sound level or due to an increasing gain on the anti-noise signals). In this case, the timbre of the environmental sounds after noise cancellation may be perceived differently by the user from the user's perception of the same environmental sounds heard with an open ear (e.g., without earbuds or headphones in or on the user's ear). By applying the gain curves 606 instead of a flat (e.g., constant) gain, environmental sounds that are passed through to the ears of the user by headphones or an earbud may be more similar in timbre to the environmental sounds in the absence of headphones or earbuds. In one or more implementations, the gain curves 606 may be derived from a loudness model which represents the average perception of human ears. In one or more other implementations, the gain curves 606 may be further tuned for an individual user (e.g., to account for a deviation in audio perception of the individual user relative to the average human).

Using the gain curves 606 may provide benefits for users who wish to reduce the loudness of environmental sounds while still being able to hear some level of the surrounding environmental sounds in a way that mirrors the way the environmental sounds would be perceived without the loudness reduction. For example, in one example use case, a user in a social setting (e.g., a bar or a party) may desire to receive a less loud and more natural perception of the sounds of the social setting (e.g., to continue enjoy the natural background sounds of the social setting while increasing their ability to have a conversation within the noisy social environment). In another example use case, a user at a concert (e.g., with an 80-90 dBA SPL) may desire to reduce the loudness of the concert (e.g., to around 65˜70 dBA SPL) without altering the timbre of the music. In one or more other use cases, applying the gain curves 606 may reduce the perceived ear pressure experienced by some users when noise cancellation is active, by increasing the gain of the low frequency environmental sounds.

FIG. 11 illustrates the architecture 301 of FIG. 4, with the addition of an environmental loudness equalizer (ELEQ) 1100. As shown, the ELEQ 1100 may modify, according to a gain curve 606 selected using a current value of the mixing value, the pass-through audio signal from the pass-through filter 300 as a function of frequency. In one or more implementations, the ELEQ 1100 may apply the gain curve by adjusting the frequency response of the pass-through filter 300 itself (e.g., by adjusting the coefficients of the pass-through filter 300 according to a selected gain curve). For example, the ELEQ 1100 may obtain the mixing value and/or the gain A, and adjust the frequency response of the pass-through filter 300 according to a loudness EQ compensation (e.g., according to a selected gain curve). In one or more other implementations, the gain curve (e.g., the frequency-dependent gain, A(f)) may be applied to the pass-through audio signal by the gain stage 306. In one or more implementations, the gain curve may be used by the pass-through filter 300 and/or the gain stage 306 while a constant (e.g., flat in frequency space) gain (e.g., 1-A, or 1-A(fc)) is applied to the noise cancellation signal from the ANC filter 302. In one or more other implementations, a frequency-dependent gain may also be applied to the noise cancellation signal from the ANC filter 302.

In one or more implementations, an electronic device, such as the electronic device 100, may provide a user with the ability to selectively turn on or off the usage of the gain curves 606. For example, some users may prefer the more natural effect of using the gain curves and may turn on the ELEQ 1100. Other users (or the same user at different times or in different acoustic environments) may prefer more noise attenuation over the naturalness of the remaining environmental sounds that pass through, and may turn off the ELEQ 1100.

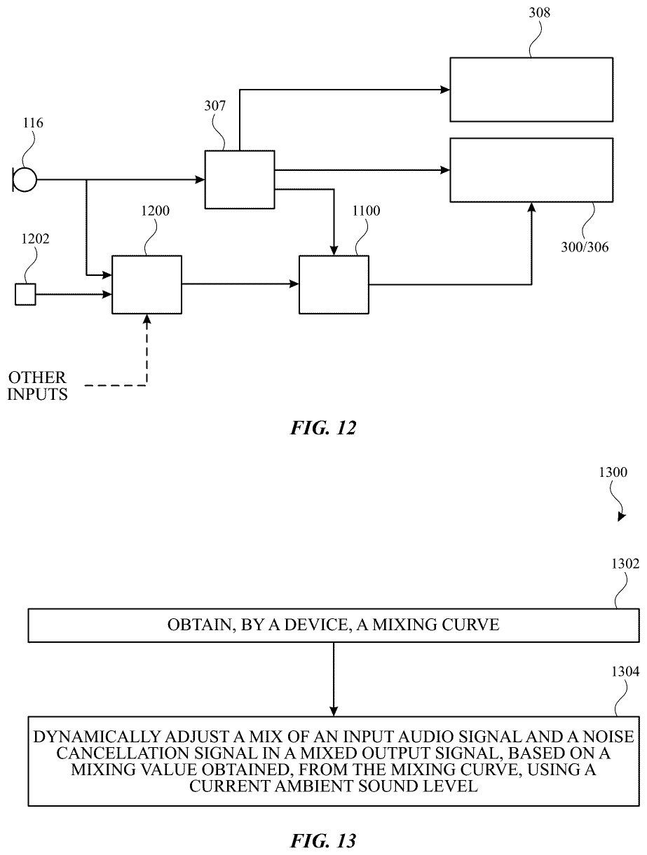

In one or more other implementations, the electronic device 100 may automatically turn on or off the ELEQ 1100 in certain acoustic environments and/or based on user preferences (e.g., user preferences input by the user, or user preferences learned using a machine learning model at the electronic device that has been trained to determine a user preference based on inputs from one or more microphones and/or other sensors at the electronic device, based on calendar information, based on purchase information, or the like). For example, FIG. 12 illustrates an example in which the architecture of the electronic device 100 includes a decision block 1200 that can be used to turn on or off the ELEQ 1100 in one or more implementations.

The decision block 1200 may be implemented, for example, as a digital signal processor (DSP) or a trained machine learning model in various implementations. In the example of FIG. 12, the decision block 1200 receives inputs from environmental sensors such as the microphone 116 and an accelerometer 1202. In this example, the decision block 1200 may determine a type of acoustic environment (e.g., a social setting such as a party, a bar, or a restaurant, or another acoustic environment such as a concert, an office, a home, a vehicle, etc.) in which the electronic device 100 is disposed, and/or a type of activity the user of the electronic device 100 is engaged in. As shown, the decision block 1200 may receive one or more other inputs in one or more implementations. As examples, the other inputs may include calendar information (e.g., calendar information indicating that the user of the electronic device 100 may be in a meeting at work, working out at the gym, at a party, or at a concert), purchase information (e.g., purchase information indicating a purchase of a ticket to a movie, a show, or a concert), activity information (e.g., indicating that the user is stationary, walking, running, or dancing), or the like.

As shown, the ELEQ 1100, the gain stage 308, the pass-through filter 300, and/or the gain stage 306 may receive the mixing value, and/or a gain (e.g., A) derived therefrom, from the adaptive controller 307 in one or more implementations. The ELEQ 1100 may determine a gain curve based on the mixing value (e.g., or the gain) and/or based on an output from the decision block 1200, and provide that gain curve to the gain stage 306 and/or the pass-through filter 300. In one or more implementations, the output from the decision block 1200 may include an instruction to activate (e.g., turn on, such as when the decision block 1200 determines that the user is at a concert or a party) or deactivate (e.g., turn off, such as when the decision block 1200 determines that the user is working in an office) the ELEQ 1100. In one or more implementations, the output from the decision block 1200 may include an instruction for the ELEQ 1100 to modify to a gain curve based on the acoustic environment and/or activity the user is engaged in. For example, in music or concert acoustic environments detected by the decision block 1200, the gain curve to applied by the gain stage 306 and/or the pass-through filter 300 can be tuned stronger (e.g., with higher bass and treble gains). As another example, in acoustic environments determined by the decision block 1200 to have large amounts of undesirable noise (e.g., traffic noise, airplane noise, fan noise, HVAC noise, people noise, appliance noise, or the like), the gain curve to applied by the gain stage 306 and/or the pass-through filter 300 can be tuned weaker to prioritize reducing the noise level. In this way, the decision block 1200 may can classify the acoustic environment and help further fine tune the ELEQ 1100 and/or the gain curves provided thereby based on the classification.

FIG. 13 illustrates a flow diagram of an example process for automatic adaptive noise cancellation in accordance with one or more implementations. For explanatory purposes, the process 1300 is primarily described herein with reference to the electronic device 100 of FIG. 1 or 2. However, the process 1300 is not limited to the electronic device 100 of FIG. 1 or 2, and one or more blocks (or operations) of the process 1300 may be performed by one or more other components and other suitable devices. Further for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

In the example of FIG. 13, at block 1302, a device (e.g., electronic device 100) may obtain a mixing curve (e.g., a mixing curve 206, such as the mixing curve 206A, the mixing curve 206B, or the mixing curve 206C). For example, the mixing curve may define a first ambient sound level (e.g., SL1) below which only a pass-through audio signal is used in a mixed output signal, a second ambient sound level (e.g., SL2) above which only a noise cancelling signal is used in the mixed output signal, and a variable amount of mixing of the pass-through audio signal and the noise cancelling signal for ambient noise levels between the first ambient sound level and the second ambient sound level.

In one or more implementations, the mixing curve may be a first mixing curve (e.g., mixing curve 206B) obtained, based on an (e.g., current) operational state of the device, from a plurality of mixing curves (e.g., the mixing curve 206A, the mixing curve 206B, or the mixing curve 206C) that correspond to a plurality of respective operational states (e.g., operational states 207A, 207B, or 207C) of the device. Each of the plurality of mixing curves (e.g., including the obtained first mixing curve) may be a function of an ambient sound level (e.g., in a physical environment of the device). As examples, the operational state of the device may include one or more of: an operational mode of the device, an environmental condition in a physical environment of the device, or a motion state of a user of the device.

At block 1304, the device (e.g., mixing circuitry 202) may dynamically adjust a mix of a pass-through audio signal and a noise cancellation signal in a mixed output signal, based on a mixing value (e.g., MV) obtained, from the mixing curve, using a current ambient sound level. For example, the mixing value may be configured to control an eardrum sound pressure level at or near an eardrum of a user of the device (e.g., by controlling the mix of the pass-through audio signal and the noise cancellation signal). In one or more implementations, the mixing value may correspond to a gain that is applied to the noise cancellation signal, and a complement of the gain may be applied to the pass-through audio signal.

The pass-through audio signal may include representations of one or more sounds in a physical environment of the device, and the noise cancellation signal may be configured to cancel (e.g., acoustically at or near the user's ear) the one or more sounds. As examples, the pass-through audio signal may be a pass-through audio signal from one or more microphones of the device and may include substantially all of the sounds recorded by the one or more microphones, or may be a processed pass-through audio signal that includes or enhances (e.g., based on filtering by a pass-through filter 300) a subset of the sounds recorded by the one or more microphones. For example, the pass-through audio signal may be configured, when output by a speaker (e.g., speaker 112) of the device, to represent the sounds the user of the device would hear in the absence of the device. The noise cancellation signal may be an anti-noise signal configured, when output by the speaker of the device, to cancel (e.g., by destructive acoustic interference) the ambient sounds that reach the ear of the user.

In one or more implementations, the first mixing curve defines a first ambient sound level (e.g., SL1) below which only the pass-through audio signal is used in the mixed output signal and a second ambient sound level (e.g., SL2) above which only the noise cancellation signal is used in the mixed output signal. The first mixing curve may further define a variable amount of mixing of the pass-through audio signal and the noise cancellation signal for ambient sound levels between the first ambient sound level and the second ambient sound level. For example, the variable amount of mixing for the ambient sound levels between the first ambient sound level and the second ambient sound level may include a first variation that changes at a first rate for ambient sound levels between the first ambient sound level and an inflection point (e.g., inflection point 500), and a second variation that changes at at least a second rate for ambient sound levels between the inflection point and the second ambient sound level. For example, the first rate of variation may be greater than (or less than) the second rate of variation. In one or more implementations, the inflection point may be a first inflection point, and the second variation that changes at at least the second rate for ambient sound levels between the inflection point and the second ambient sound level may include (i) a first portion of the second variation that changes at the second rate for ambient sound levels between the first inflection point and a second inflection point (e.g., second inflection point 502) and (ii) a second portion of the second variation that changes at a third rate for ambient sound levels between the second inflection point and the second ambient sound level.

In one or more implementations, while dynamically adjusting the mix of the pass-through audio signal and the noise cancellation signal in the mixed output signal, based on the mixing value obtained, from the first mixing curve, using the current ambient sound level, the electronic device may detect a change in the operational state of the device; obtain, based on detected change in the operational state, a second mixing curve (e.g., mixing curve 206C) from the plurality of mixing curves; and dynamically adjust the mix of the pass-through audio signal and the noise cancellation signal in the mixed output signal, based on a different mixing value obtained, from the second mixing curve, using the current ambient sound level.

In one or more implementations, the electronic device may determine the operational state of the device at least in part by: identifying a first operational state of the device occurring concurrently with a second operational state of the device; and determining the operational state by selecting (e.g., from a priority list for operational states) a higher priority one of the first operational state and the second operational state.

In one or more implementations, dynamically adjusting the mix of the pass-through audio signal and the noise cancellation signal in the mixed output signal, based on the mixing value obtained, from the first mixing curve, using the current ambient sound level may include: obtaining, at a first time, a first measure of the current ambient sound level; generating, at substantially the first time, the mixed output signal by obtaining the mixing value from the first mixing curve based on the first measure of the current ambient sound level; obtaining, at a second time, a second measure of the current ambient sound level; and generating, at substantially the second time, the mixed output signal by obtaining a different mixing value from the first mixing curve based on the second measure of the current ambient sound level. In one or more implementations, the device may also dynamically adjust an output of a speaker (e.g., speaker 112) of the device based on the mixed output signal.

In one or more implementations, the process 1300 may also include modifying, prior to obtaining the mixing value from the first mixing curve, the first mixing curve based on a user input. The process 1300 may also include obtaining the mixing value from the modified mixing curve (e.g., modified mixing curve 206BL or modified mixing curve 206BH of FIG. 9, or a modified mixing curve within the range 702 or the range 704 of FIG. 7).

In one or more implementations, dynamically adjusting the mix of the pass-through audio signal and the noise cancellation signal in the mixed output signal, based on the mixing value obtained, from the first mixing curve, using the current ambient sound level may include applying (e.g., by the gain stage 306 or by adjusting the frequency characteristics of the pass-through filter 300) a frequency-dependent gain (e.g., a gain curve 606, such as the gain curve 606A, 606B, 606C, 606D, 606E, 606F, or 606G) to the pass-through audio signal prior to generating the mixed output signal. For example, the frequency-dependent gain may have a frequency dependence that is determined (e.g., selected, by selecting a gain curve such as gain curve 606C from a set of gain curves 606) based on the mixing value. In one or more implementations, the device may obtain an environment classification of an acoustic environment of the device using a machine learning model (e.g., decision block 1200) at the device. The machine learning model may have been trained to classify acoustic environments based at least in part on an audio input (e.g., in a microphone signal and/or an accelerometer signal) to the machine learning model (e.g., along with one or more other inputs as described in connection with FIG. 12). The device determine the frequency-dependent gain based on the environment classification. For example, determining the frequency-dependent gain may include turning on or off an environment loudness equalizer (e.g., ELEQ 1100) or modifying a tuning or EQ of the frequency-dependent gain based on the environment classification.

As described above, one aspect of the present technology is the gathering and use of data available from specific and legitimate sources for providing automatic adaptive noise cancellation for electronic devices. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for operating an electronic device to provide automatic adaptive noise cancellation for electronic devices. Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device to provide automatic adaptive noise cancellation for electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

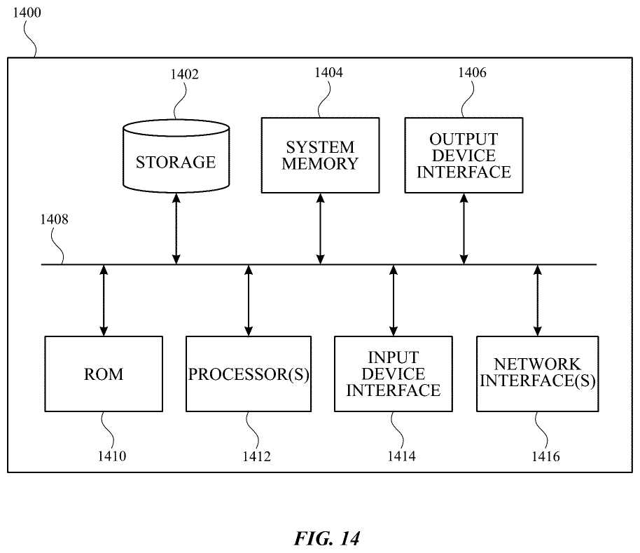

FIG. 14 illustrates an electronic system 1400 with which one or more implementations of the subject technology may be implemented. The electronic system 1400 can be, and/or can be a part of, one or more of the electronic device 100 shown in FIG. 1 or 2. The electronic system 1400 may include various types of computer readable media and interfaces for various other types of computer readable media. The electronic system 1400 includes a bus 1408, one or more processing unit(s) 1412, a system memory 1404 (and/or buffer), a ROM 1410, a permanent storage device 1402, an input device interface 1414, an output device interface 1406, and one or more network interfaces 1416, or subsets and variations thereof.

The bus 1408 collectively represents all system, peripheral, and chipset buses that communicatively connect the numerous internal devices of the electronic system 1400. In one or more implementations, the bus 1408 communicatively connects the one or more processing unit(s) 1412 with the ROM 1410, the system memory 1404, and the permanent storage device 1402. From these various memory units, the one or more processing unit(s) 1412 retrieves instructions to execute and data to process in order to execute the processes of the subject disclosure. The one or more processing unit(s) 1412 can be a single processor or a multi-core processor in different implementations.

The ROM 1410 stores static data and instructions that are needed by the one or more processing unit(s) 1412 and other modules of the electronic system 1400. The permanent storage device 1402, on the other hand, may be a read-and-write memory device. The permanent storage device 1402 may be a non-volatile memory unit that stores instructions and data even when the electronic system 1400 is off. In one or more implementations, a mass-storage device (such as a magnetic or optical disk and its corresponding disk drive) may be used as the permanent storage device 1402.

In one or more implementations, a removable storage device (such as a flash drive) may be used as the permanent storage device 1402. Like the permanent storage device 1402, the system memory 1404 may be a read-and-write memory device. However, unlike the permanent storage device 1402, the system memory 1404 may be a volatile read-and-write memory, such as random access memory. The system memory 1404 may store any of the instructions and data that one or more processing unit(s) 1412 may need at runtime. In one or more implementations, the processes of the subject disclosure are stored in the system memory 1404, the permanent storage device 1402, and/or the ROM 1410. From these various memory units, the one or more processing unit(s) 1412 retrieves instructions to execute and data to process in order to execute the processes of one or more implementations.

The bus 1408 also connects to the input and output device interfaces 1414 and 1406. The input device interface 1414 enables a user to communicate information and select commands to the electronic system 1400. Input devices that may be used with the input device interface 1414 may include, for example, alphanumeric keyboards and pointing devices (also called “cursor control devices”). The output device interface 1406 may enable, for example, the display of images generated by electronic system 1400. Output devices that may be used with the output device interface 1406 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 14, the bus 1408 also couples the electronic system 1400 to one or more networks and/or to one or more network nodes, through the one or more network interface(s) 1416. In this manner, the electronic system 1400 can be a part of a network of computers (such as a LAN, a wide area network (“WAN”), or an Intranet, or a network of networks, such as the Internet. Any or all components of the electronic system 1400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, by a device and based on an operational state of the device, a first mixing curve from a plurality of mixing curves that correspond to a plurality of respective operational states of the device, wherein each of the plurality of mixing curves is a function of an ambient sound level; and
dynamically adjusting a mix of a pass-through audio signal and a noise cancellation signal in a mixed output signal, based on a mixing value obtained, from the first mixing curve, using a current ambient sound level.

2. The method of claim 1, wherein the pass-through audio signal comprises representations of one or more sounds in a physical environment of the device, and wherein the noise cancellation signal is configured to cancel the one or more sounds.

3. The method of claim 2, further comprising
dynamically adjusting an output of a speaker of the device based on the mixed output signal.

4. The method of claim 1, wherein the first mixing curve defines a first ambient sound level below which only the pass-through audio signal is used in the mixed output signal and a second ambient sound level above which only the noise cancellation signal is used in the mixed output signal.

5. The method of claim 4, wherein the first mixing curve further defines a variable amount of mixing of the pass-through audio signal and the noise cancellation signal for ambient sound levels between the first ambient sound level and the second ambient sound level.

6. The method of claim 5, wherein the variable amount of mixing for the ambient sound levels between the first ambient sound level and the second ambient sound level comprises a first variation that changes at a first rate for ambient sound levels between the first ambient sound level and an inflection point, and a second variation that changes at at least a second rate for ambient sound levels between the inflection point and the second ambient sound level.

7. The method of claim 6, wherein the first rate of variation is greater than the second rate of variation.

8. The method of claim 6, wherein the inflection point comprises a first inflection point, and wherein the second variation that changes at at least the second rate for ambient sound levels between the inflection point and the second ambient sound level comprises a first portion of the second variation that changes at the second rate for ambient sound levels between the first inflection point and a second inflection point, and a second portion of the second variation that changes at a third rate for ambient sound levels between the second inflection point and the second ambient sound level.

9. The method of claim 1, further comprising:
while dynamically adjusting the mix of the pass-through audio signal and the noise cancellation signal in the mixed output signal, based on the mixing value obtained, from the first mixing curve, using the current ambient sound level, detecting a change in the operational state of the device;
obtaining, based on a detected change in the operational state, a second mixing curve from the plurality of mixing curves; and
dynamically adjusting the mix of the pass-through audio signal and the noise cancellation signal in the mixed output signal, based on a different mixing value obtained, from the second mixing curve, using the current ambient sound level.

10. The method of claim 1, wherein the operational state of the device comprises one or more of: an operational mode of the device, an environmental condition in a physical environment of the device, or a motion state of a user of the device.

11. The method of claim 1, further comprising determining the operational state of the device at least in part by:
identifying a first operational state of the device occurring concurrently with a second operational state of the device; and
determining the operational state by selecting a higher priority one of the first operational state and the second operational state.

12. The method of claim 1, wherein dynamically adjusting the mix of the pass-through audio signal and the noise cancellation signal in the mixed output signal, based on the mixing value obtained, from the first mixing curve, using the current ambient sound level comprises:
obtaining, at a first time, a first measure of the current ambient sound level;
generating, at substantially the first time, the mixed output signal by obtaining the mixing value from the first mixing curve based on the first measure of the current ambient sound level;
obtaining, at a second time, a second measure of the current ambient sound level; and
generating, at substantially the second time, the mixed output signal by obtaining a different mixing value from the first mixing curve based on the second measure of the current ambient sound level.

13. The method of claim 1, wherein the mixing value is configured to control an eardrum sound pressure level.

14. The method of claim 1, further comprising:
modifying, prior to obtaining the mixing value from the first mixing curve, the first mixing curve based on a user input; and
obtaining the mixing value from the modified mixing curve.

15. The method of claim 1, wherein dynamically adjusting the mix of the pass-through audio signal and the noise cancellation signal in the mixed output signal, based on the mixing value obtained, from the first mixing curve, using the current ambient sound level comprises applying a frequency-dependent gain to the pass-through audio signal prior to generating the mixed output signal, wherein the frequency-dependent gain has a frequency dependence that is determined based on the mixing value.

16. The method of claim 15, further comprising:
obtaining an environment classification of an acoustic environment of the device using a machine learning model at the device, the machine learning model having been trained to classify acoustic environments based at least in part on an audio input to the machine learning model; and
determining the frequency-dependent gain based on the environment classification.

17. A processor, configured to:
obtain, based on an operational state of a device, a first mixing curve from a plurality of mixing curves that correspond to a plurality of respective operational states of the device, wherein each of the plurality of mixing curves is a function of an ambient sound level; and
dynamically adjust a mix of a pass-through audio signal and a noise cancellation signal in a mixed output signal, based on a mixing value obtained, from the first mixing curve, using a current ambient sound level.

18. The processor of claim 17, wherein the pass-through audio signal comprises representations of one or more sounds in a physical environment of the device, and wherein the noise cancellation signal is configured to cancel the one or more sounds.

19. The processor of claim 17, wherein the first mixing curve defines a first ambient sound level below which only the pass-through audio signal is used in the mixed output signal and a second ambient sound level above which only the noise cancellation signal is used in the mixed output signal.

20. The processor of claim 19, wherein the first mixing curve further defines a variable amount of mixing of the pass-through audio signal and the noise cancellation signal for ambient sound levels between the first ambient sound level and the second ambient sound level.

21. The processor of claim 20, wherein the variable amount of mixing for the ambient sound levels between the first ambient sound level and the second ambient sound level comprises a first variation that changes at a first rate for ambient sound levels between the first ambient sound level and an inflection point, and a second variation that changes at at least a second rate for ambient sound levels between the inflection point and the second ambient sound level.

22. A device, comprising:
memory; and
processing circuitry configured to:
obtain a mixing curve; and
dynamically adjust a mix of a pass-through audio signal and a noise cancellation signal in a mixed output signal, based on a mixing value obtained, from the mixing curve, using a current ambient sound level, wherein the mixing curve defines a first ambient sound level below which only pass-through audio signal is used in the mixed output signal, a second ambient sound level above which only the noise cancelling signal is used in the mixed output signal, and a variable amount of mixing of the pass-through audio signal and the noise cancelling signal for ambient noise levels between the first ambient sound level and the second ambient sound level.

23. The device of claim 22, wherein the processing circuitry is configured to obtain the mixing curve based on an operational state of the device.
